(19) United States
(12) Patent Application Publication
(10) Pub. No.: US 2009/0327946 A1
(43) Pub. Date: Dec. 31, 2009

(54) SYSTEMS AND METHODS FOR TRACKING PATENT RELATED INFORMATION

(76) Inventors: Mark D. Stignani, Minneapolis, MN (US); David Rosenblatt, Randolph, NJ (US); David Hendricksen, Eagan, NJ (US); Samuel Goodrich, Minneapolis, MN (US)

Correspondence Address: SCHWEGMAN, LUNDBERG & WOESSNER, P.A., P.O. BOX 2938, MINNEAPOLIS, MN, 55402, US

(21) Appl. No.: 12/415,917

(22) Filed: Mar. 31, 2009

Related U.S. Application Data
(60) Provisional application No. 61/072,578, filed on Mar. 31, 2008.
(60) Provisional application No. 61/133,610, filed on Jun. 30, 2008.

(51) Int. Cl. G06F 3/048

(52) U.S. Cl. 715/776; 715/804; 715/234

(57) ABSTRACT

To facilitate faster, more efficient, and more effective extraction of information from patent file histories, the present inventors, devised among other things, systems and method for tracking changes to patent claims, specifications, and/or drawings that are shown in file wrappers. One exemplary system graphically displays the patent family and/or file wrapper timeline. Another reports information about a specific patent, an examiner, a technology area, and other patent related information that can be pulled from the file wrapper.

### RELATED APPLICATIONS

The present application claims priority to U.S. Provisional Patent Applications 61/072,578 and 61/133,610 which were filed respectively on Mar. 31, 2008 and Jun. 30, 2008. Both of these applications are incorporated herein by reference.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright C) 2007, Thomson Global Resources.

### TECHNICAL FIELD

Various embodiments of the present invention concern systems and methods for automated or semi-automated processing and extracting information from patent file wrappers, or file histories.

### BACKGROUND

Patent attorneys spend an enormous amount of time reading and analyzing patent file wrappers for both issued patents and pending applications. Patent litigators scrutinize every word, phrase, and figure within the issued patent, the prior art at issue, and the arguments made to get the patent granted, looking for loopholes and gaps in coverage. Patent prosecutors—that is those who design and build the patents that litigators fight about—usually spend a significant time studying what has been previously done in a pending application, sometimes because months have past since they last looked at the application or sometimes because they have taken over prosecution of the application from another attorney in their firm or even from another law firm. In either case, they need to know and understand the full procedural, legal, and technical context of the application to make the best strategic decisions.

One problem the present inventors recognized was that, regardless of the reason for studying a file wrapper, it is important to identify what revisions have been made to the claims or specification during prosecution. Since these changes are highlighted within the responses to office actions, they are fairly easy to recognize. However, making notes of all the changes for a single patent history, much less a series or family of patents, not only can be tedious and time consuming, but also difficult to do without error. Another problem that the present inventors recognized was that litigators and prosecutors are also interested in graphics, statistics, and information about their current patent or application or a set of patents/applications.

Accordingly, the present inventors have identified a need to improve the process for assessing file histories.

### SUMMARY

To address one or more of these and/or other needs, the present inventors, devised among other things, systems and method for tracking changes to claims, specifications, and/or drawings that are shown in file wrappers. One exemplary system graphically displays the patent family and/or file wrapper timeline. Another reports information about a specific patent, an examiner, a technology area, and other patent related information that can be pulled from the file wrapper.

### BRIEF DESCRIPTION OF THE DRAWINGS

FIG. 1A is a block diagram of an exemplary system for converting, shredding, storing documents corresponding to one or more embodiments of the present invention.

FIG. 1B is a block diagram of an exemplary system for establishing relationships between individual document components corresponding to one or more embodiments of the present invention.

FIG. 2 is a screenshot of an interface of an exemplary system for tracking and analyzing patent file wrapper changes corresponding to one or more embodiments of the present invention.

FIG. 3 is a screenshot of an interface of an exemplary system for tracking and analyzing patent file wrapper changes corresponding to one or more embodiments of the present invention.

FIG. 4 is a screenshot of an interface of an exemplary system for tracking and analyzing patent file wrapper changes corresponding to one or more embodiments of the present invention.

FIG. 5 is a screenshot of an interface of an exemplary system for displaying table of contents within file wrapper corresponding to one or more embodiments of the present invention.

FIG. 6 is a screenshot of an interface of an exemplary system for tracking and analyzing patent file wrapper changes corresponding to one or more embodiments of the present invention.

FIG. 7 is a screenshot of an interface of an exemplary system for tracking and analyzing patent file wrapper changes corresponding to one or more embodiments of the present invention.

FIG. 8 is a screenshot of an interface of an exemplary system for tracking and analyzing patent file wrapper changes corresponding to one or more embodiments of the present invention.

FIG. 9 is a screenshot of an interface of an exemplary system for tracking and analyzing patent file wrapper changes corresponding to one or more embodiments of the present invention.

FIG. 10 is a screenshot of an interface of an exemplary system for tracking and analyzing patent file wrapper changes corresponding to one or more embodiments of the present invention.

FIG. 11 is a screenshot of an interface of an exemplary system for tracking and analyzing patent file wrapper changes corresponding to one or more embodiments of the present invention.

FIG. 12 is a screenshot of an interface of an exemplary system for tracking and analyzing patent file wrapper changes corresponding to one or more embodiments of the present invention.

FIG. 13 is a screenshot of an interface of an exemplary system for tracking and analyzing patent file wrapper changes corresponding to one or more embodiments of the present invention.

FIG. 14 is a screenshot of an interface of an exemplary system for related patent history corresponding to one or more embodiments of the present invention.

FIG. 15 is a screenshot of an interface of an exemplary system for related patent history corresponding to one or more embodiments of the present invention.

FIG. 16 is a screenshot of an interface of an exemplary system for displaying a graphical patent file history corresponding to one or more embodiments of the present invention.

FIG. 17 is a screenshot of an interface of an exemplary system for displaying a graphical patent family corresponding to one or more embodiments of the present invention.

FIG. 18 is a screenshot of an interface of an exemplary system for tracking and analyzing patent file wrapper changes with respect to drawings corresponding to one or more embodiments of the present invention.

FIG. 19 is a screenshot of an interface of an exemplary system for altering user of patent file wrapper changes corresponding to one or more embodiments of the present invention.

FIG. 20 is a screenshot of an interface of an exemplary system for tracking and analyzing defined terms within patent file wrapper corresponding to one or more embodiments of the present invention.

FIG. 21 is a screenshot of an interface of an exemplary system for tracking and analyzing defined terms within patent file wrapper corresponding to one or more embodiments of the present invention.

FIG. 22 is a screenshot of an interface of an exemplary search template for tracking and analyzing patent file wrapper changes corresponding to one or more embodiments of the present invention.

### BRIEF DESCRIPTION OF EXEMPLARY EMBODIMENT(S)

This description, which incorporates the drawings and the appended claims, describes one or more specific embodiments of an invention. These embodiments, offered not to limit but only to exemplify and teach the invention, are shown and described in sufficient detail to enable those skilled in the art to implement or practice the invention. Thus, where appropriate to avoid obscuring the invention, the description may omit certain information known to those of skill in the art.

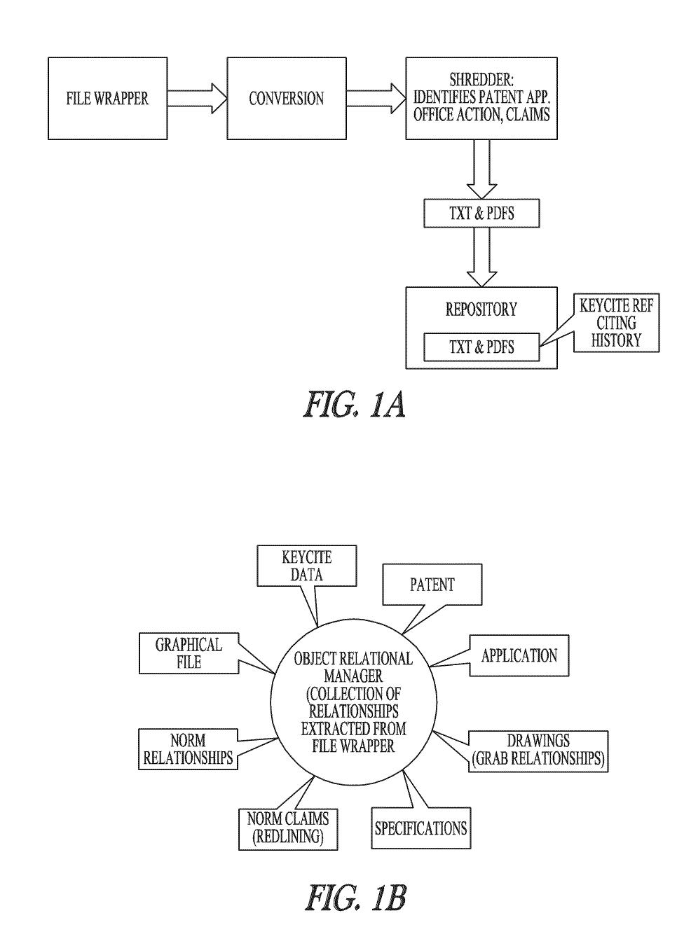

FIG. 1a, one embodiment of the present invention, an electronic version of the file history/wrapper is received into a conversion system. In this embodiment, the file wrapper is in pdf format; however, the file wrapper can be in other formats as well. The conversion system shreds the file wrapper into several individual components. For example, if a file wrapper has the application, office action and response to office action, the conversion system could shred the wrapper into the following individual components: specification, claims, drawings, office action, and the amended claims and remarks from response. Each individual component is identified and converted into a pdf and text format. Once the shredding and converting are complete, all the files are stored within a repository. FIG. 1b, the collection of relationships between the individual components is loaded into an object relationship manager. This relationship manager stores and retrieves relationships between the individual components to/from the databases. In addition, certain metadata is extracted and stored within a metadata authority. This metadata may include but not be limited to number of original claims, number of issued claims, number of office actions, number of responses, number of request for continued examinations, etc.

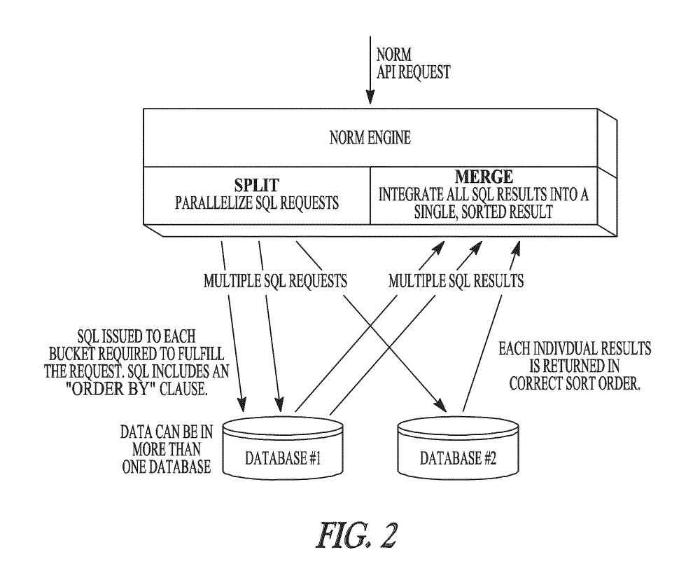

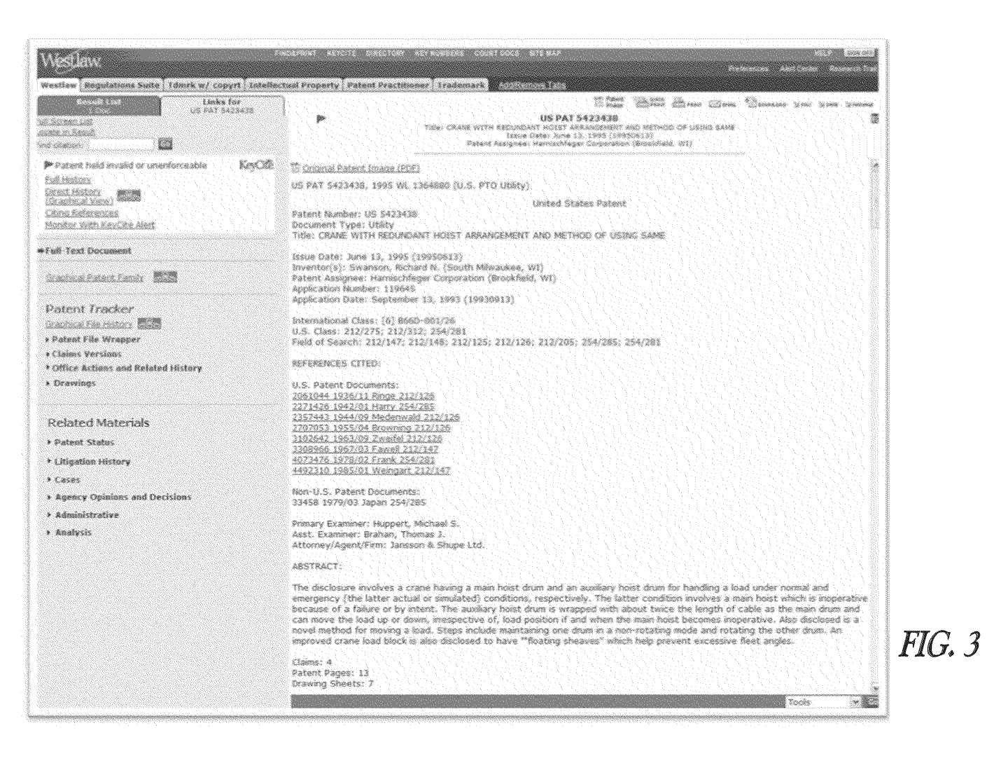

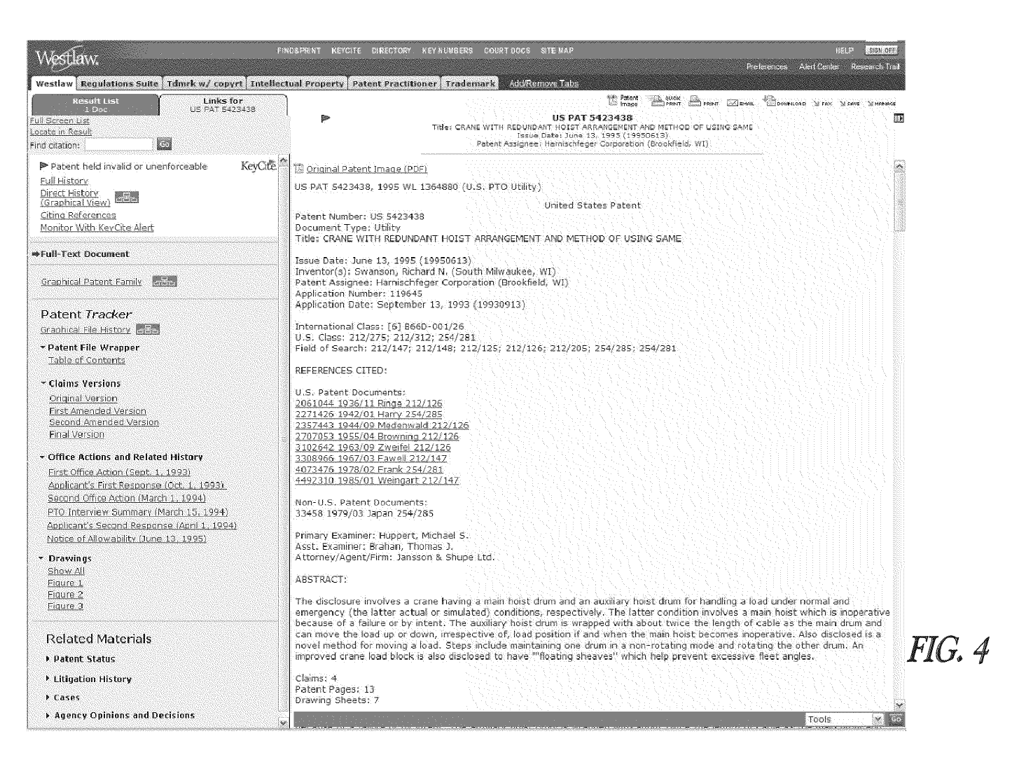

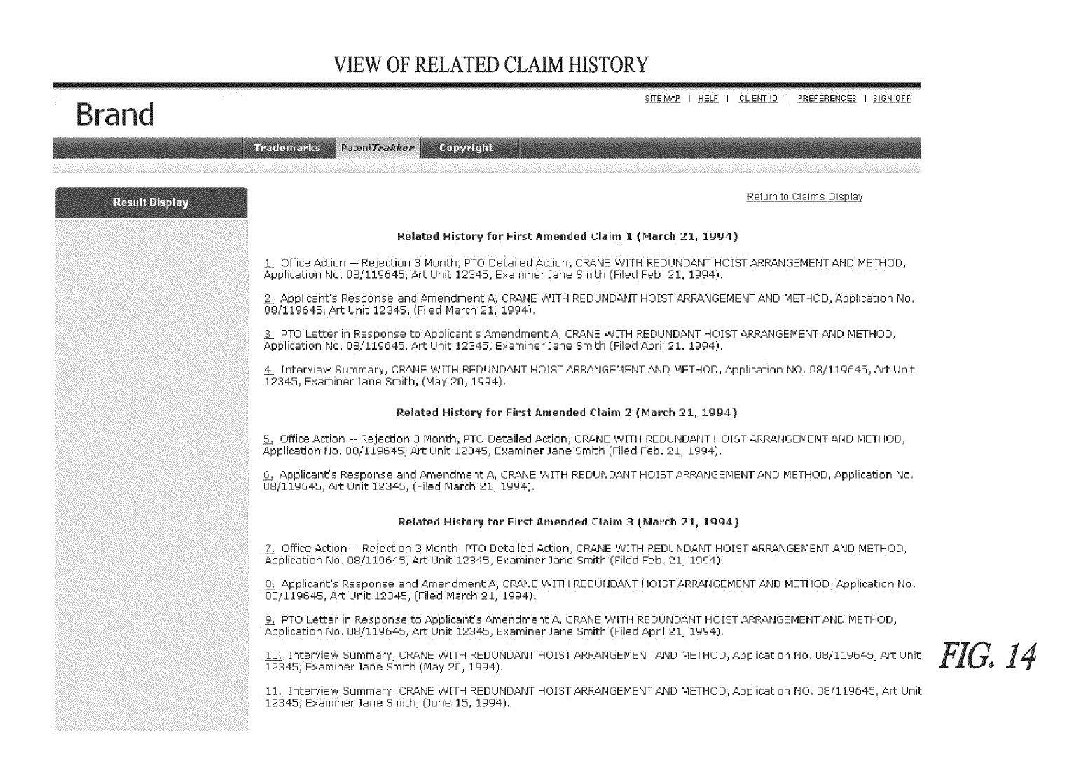

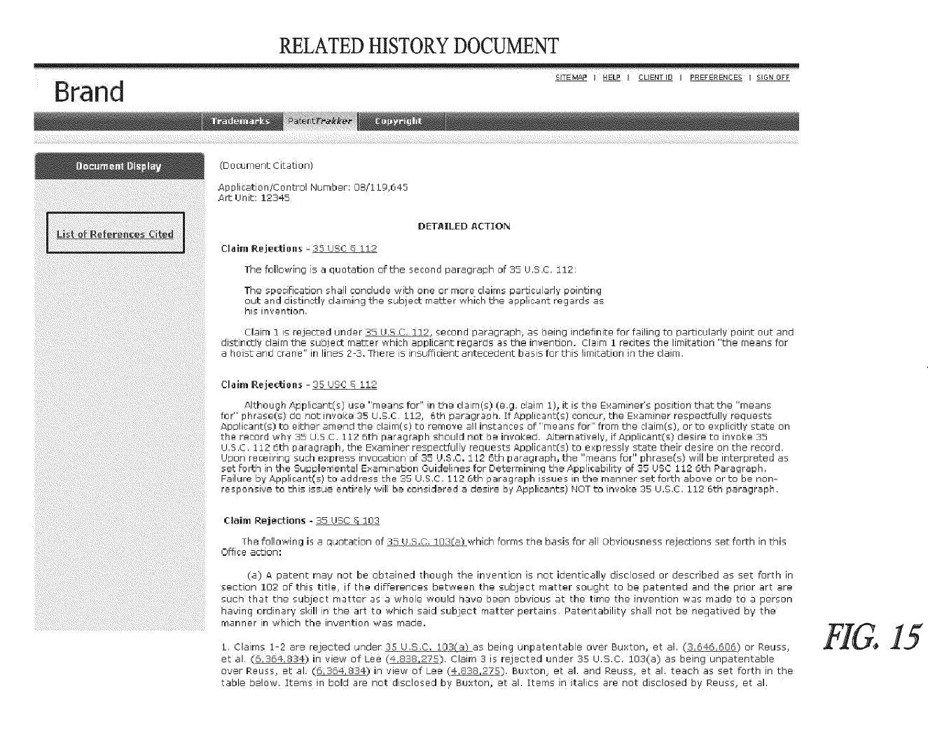

When a user wants to access a patent/application and the file wrapper, that patent/application is retrieved from the appropriate patent/application repository. Simultaneously, FIG. 2, an application programming interface (API) requests the relationship information from the relationship manager. The relationship manager then sends a SQL request to each database required to fulfill the request. This SQL request also includes an “Order By” clause which sorts the results in the correct order. Once the request is complete, each individual result is returned in correct sort order. The relationship manager integrates all of the individual SQL results into a single, sorted result. This single, sorted result of relationships is displayed to the user (FIG. 4—left pane) along with the patent/application file FIG. 3. In an embodiment of the present invention, each individual component's file is retrieved from the repository when the user selects a link that requests that file (See FIGS. 14-15).

FIG. 3 shows a user retrieving a certain patent number on Westlaw®. The left pane displays a “Patent Trakker” section where the user may utilize the tools by clicking on the arrow next to the desired heading. FIG. 4 exemplifies how the user selects the arrow(s) that he/she is interested in and the menu expands to display the items under that heading(s). Also within this screen is the hyperlink for a “Graphical File History” and “Graphical Patent Family.” These options are discussed later.

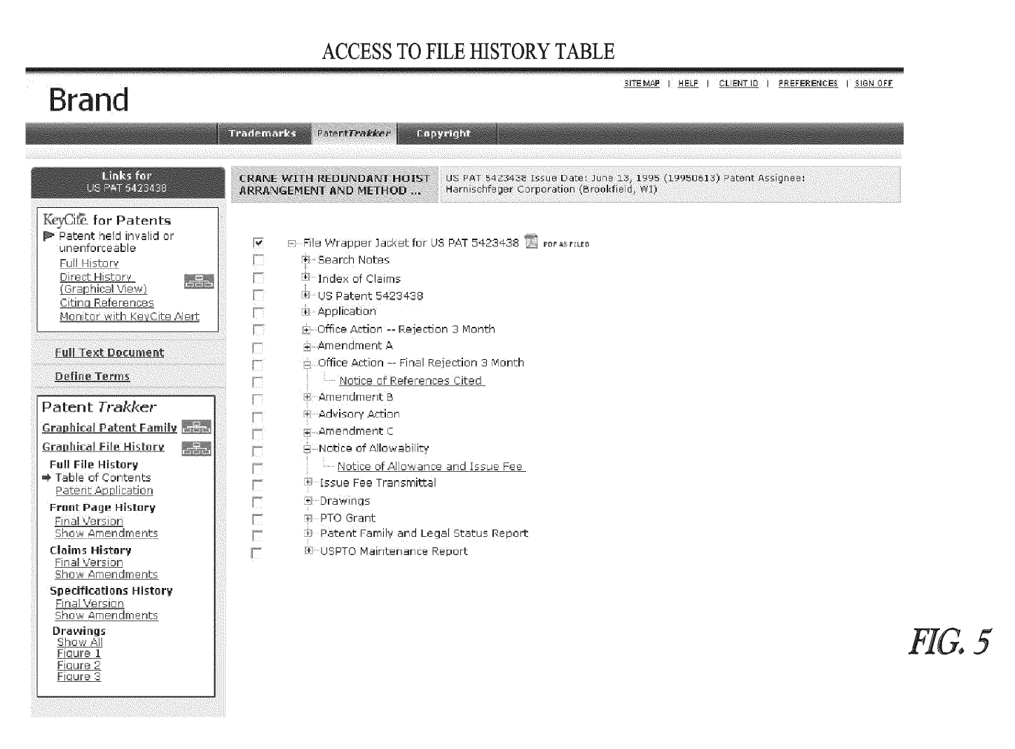

If the user selects the Table of Contents sub-heading under the File Wrapper heading, FIG. 5 displays the individual components that were saved for that file wrapper. These individual components expand or collapse depending on what the user selects. To the left of the table of contents are check boxes that enable the user to check which components he/she would like to see.

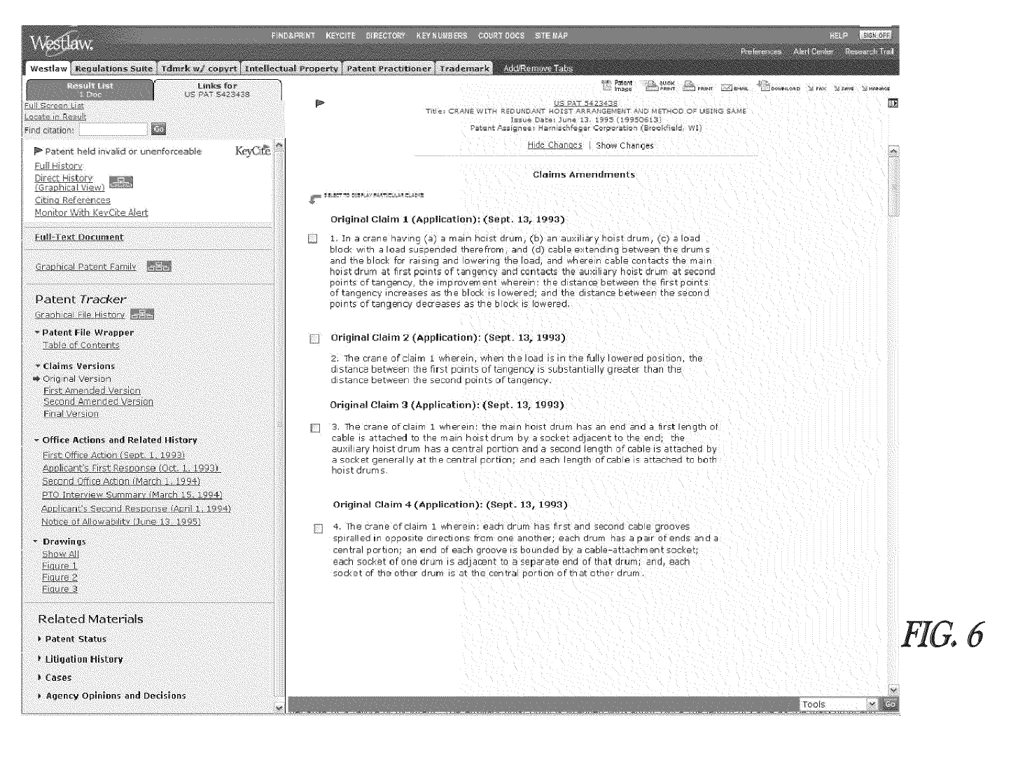

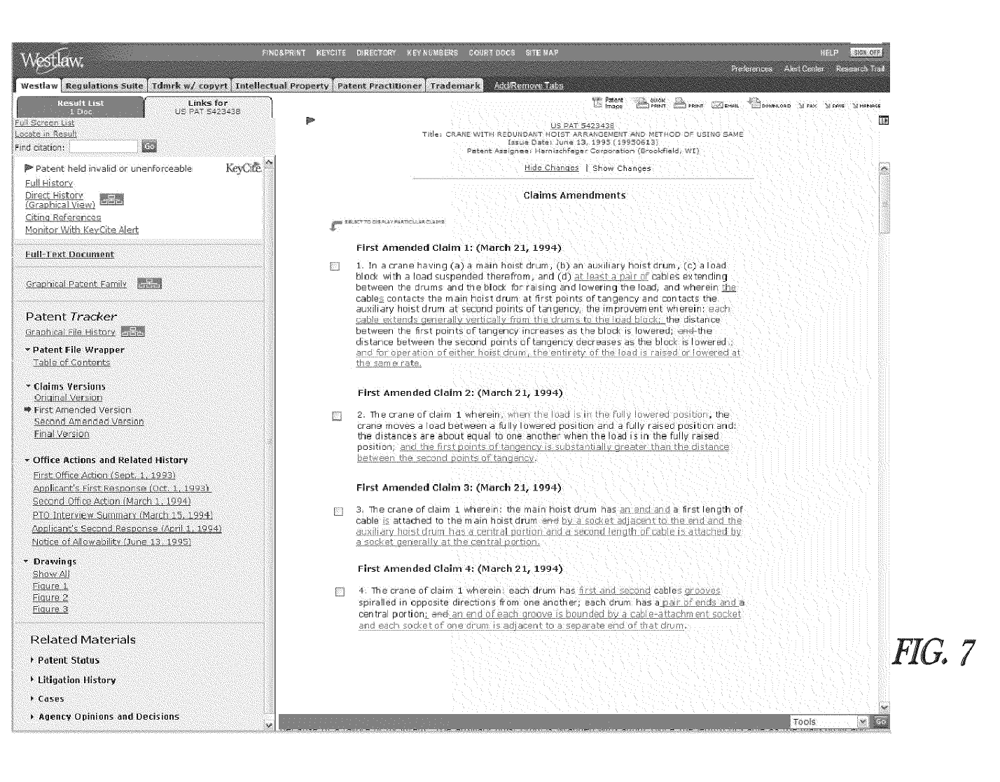

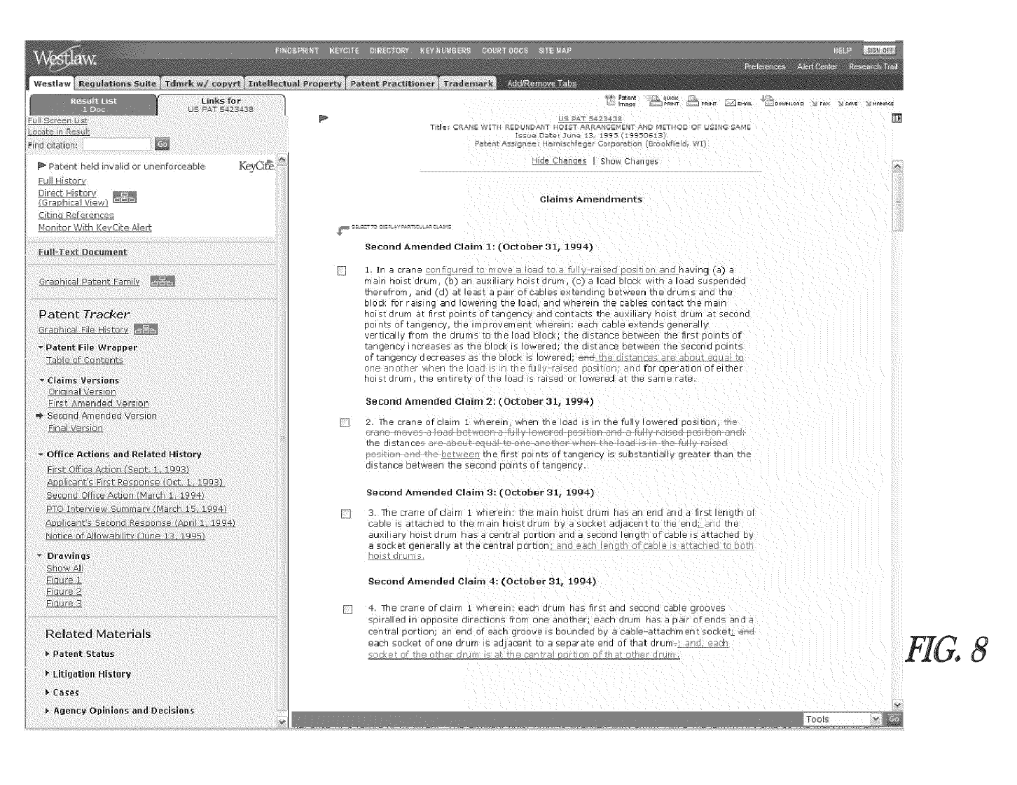

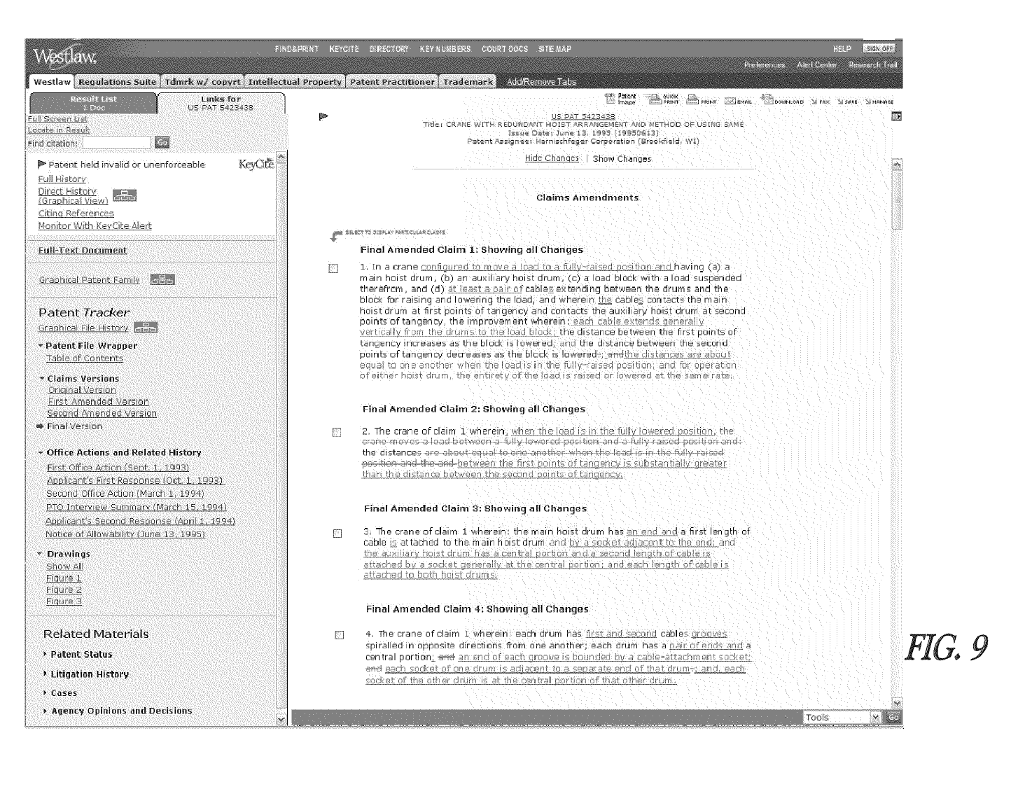

In FIG. 6, under the “Claims Versions” heading, each version of the claims is listed and selectable. In response to the user having selected the original claim set link (which indicated via the arrow), the original claims appear within the main display region along with the date that they were filed. In addition, to the left of the numbered claims is a check box that allows the user to select only the claims he/she is interested in. FIGS. 7-9 show the interfaces that are displayed in response to the user respectively selecting each version of the claims. Each version highlights the changes within the claim set from the previous version along with the date in which the change was entered. In the final version of claims (FIG. 9), there is an option to view all of the changes that happened through the prosecution history. In addition, a “Hide Changes” hyperlink is located at the top of the main display which allows the user to see the claims version without the highlighting. If the change is underlined, an addition is entered. If the change is strikethrough, a deletion is entered. While the figures utilize underlining and strikethrough, brackets and/or other editing methods are acceptable.

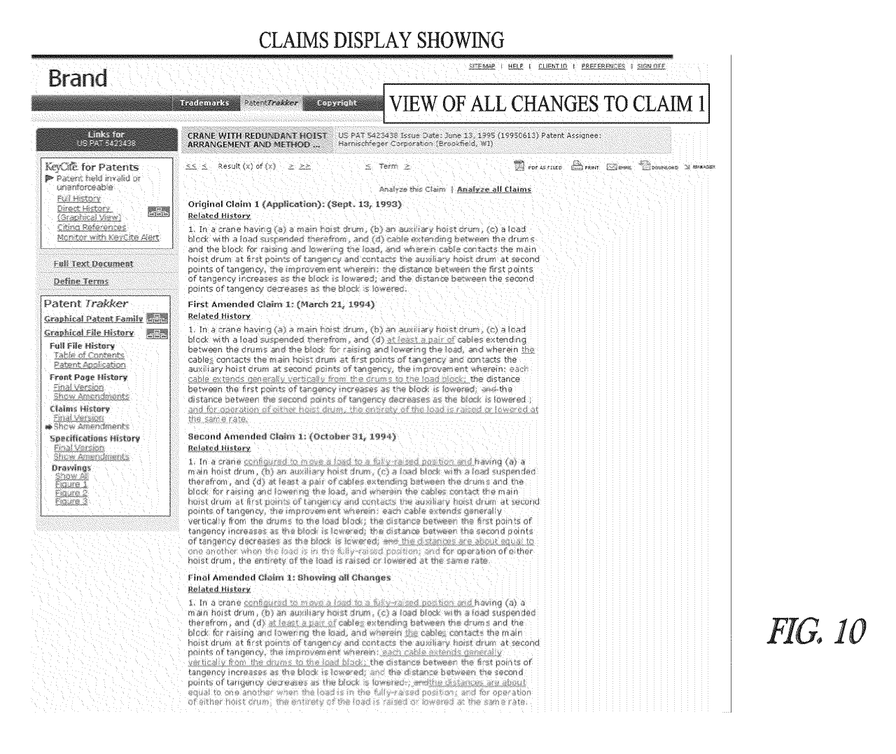

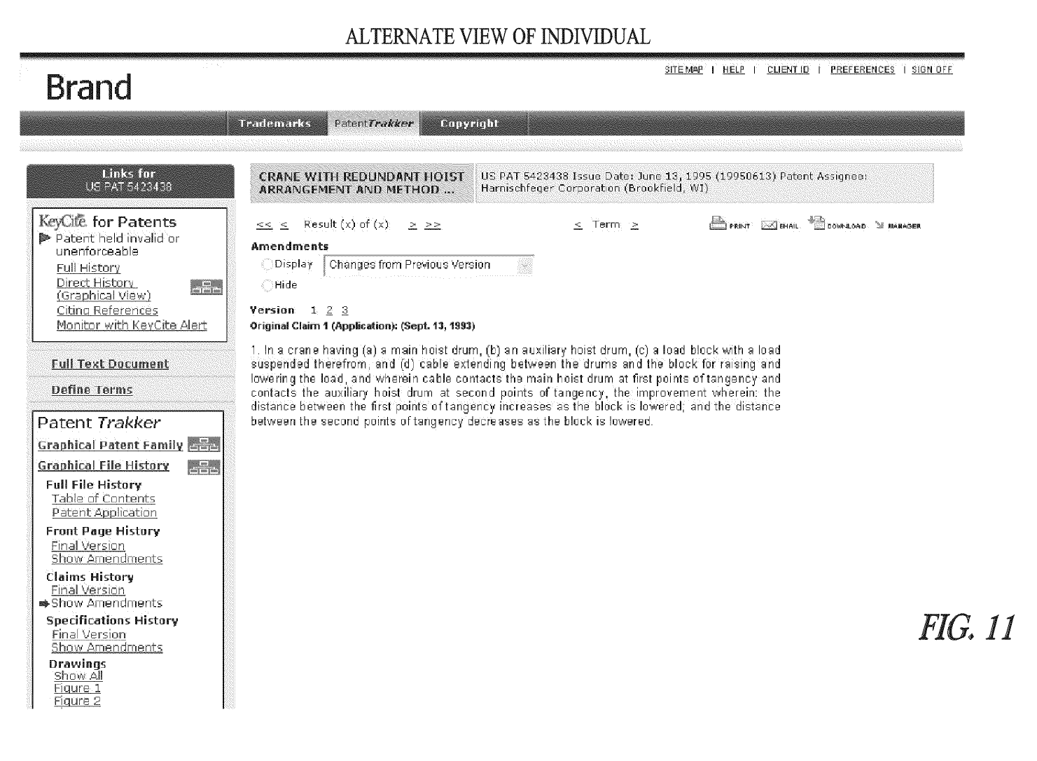

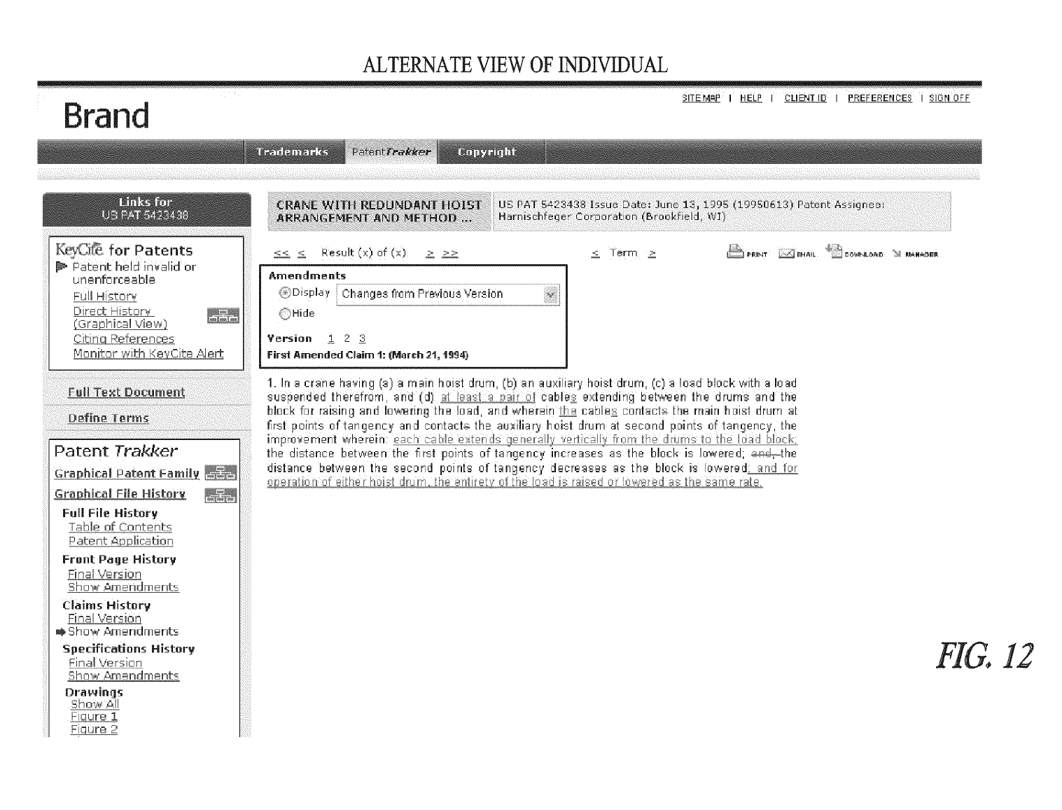

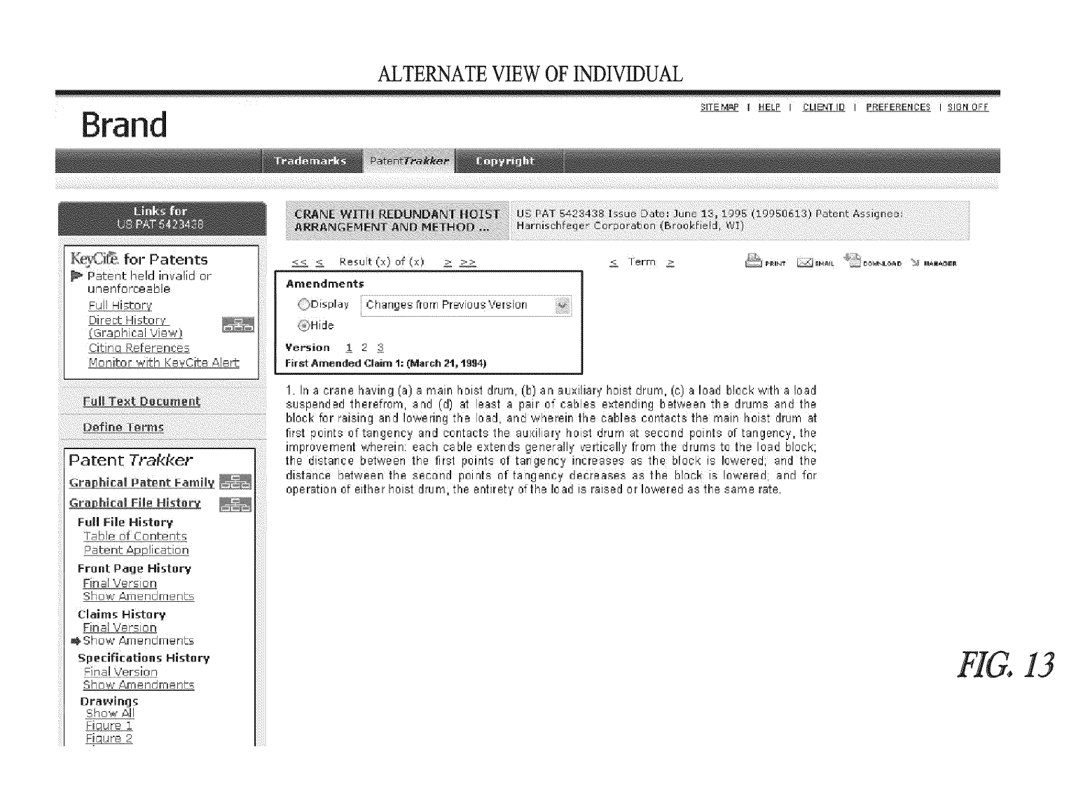

FIG. 10 shows an example of what the user would see in response to a selection to view the claim changes for an individual claim. This view allows the user to see all the changes to a single claim. The single claim display is very useful when an attorney only needs to focus on one or two claims within the application. FIGS. 11-13 show alternative views of individual claims that are present in some embodiments.

In FIG. 10, a “Related History” link is located under the claim version. When the user selects this link, all the related history (office action, office action response, interview summary, etc.) is displayed for that version. FIG. 14 displays the related history for first amended claim set. However, if the user has chosen to narrow the number of claims he/she is tracking then only the related history shows for those chosen claims. If the user would like to see the reasons for rejection within a certain office action or more detail in another related history component, he/she may click on the numbered link. For example, FIG. 15 demonstrates the detailed rejections given by an examiner for a certain office action. Related history includes key parts of the US Patent and Trademark Office (PTO) office actions that detail the PTO's rejection(s) or suggested modification(s) of the claims, specifications, etc. It may also include the applicant's response, and their detailed reasoning/justification(s) behind their proposed amendments. In the left pane, the “List of References Cited” link produces a list of the references cited for that particular office action.

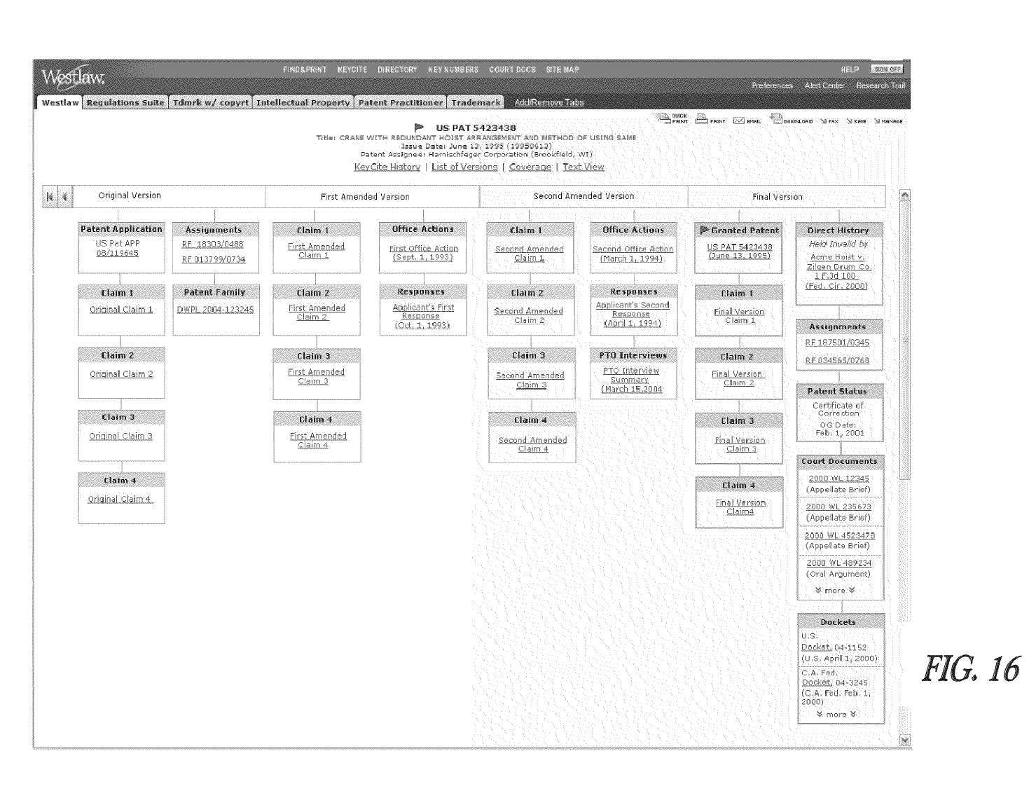

FIG. 3 shows a link to the “Graphical File History.” When the user clicks this link, FIG. 16 displays a timeline of different versions of the claim sets. The user may select any link to display all detailed information about that link. Also included in this graphical display is other documentation that may be of use to the user. This documentation may include but is not limited to assignments, patent family, direct history, patent status, court documents, and dockets. The user has the option to print, email or download this and all other graphical displays or any other documentation within claim tracking system from the toolbar in the upper right hand corner of main display.

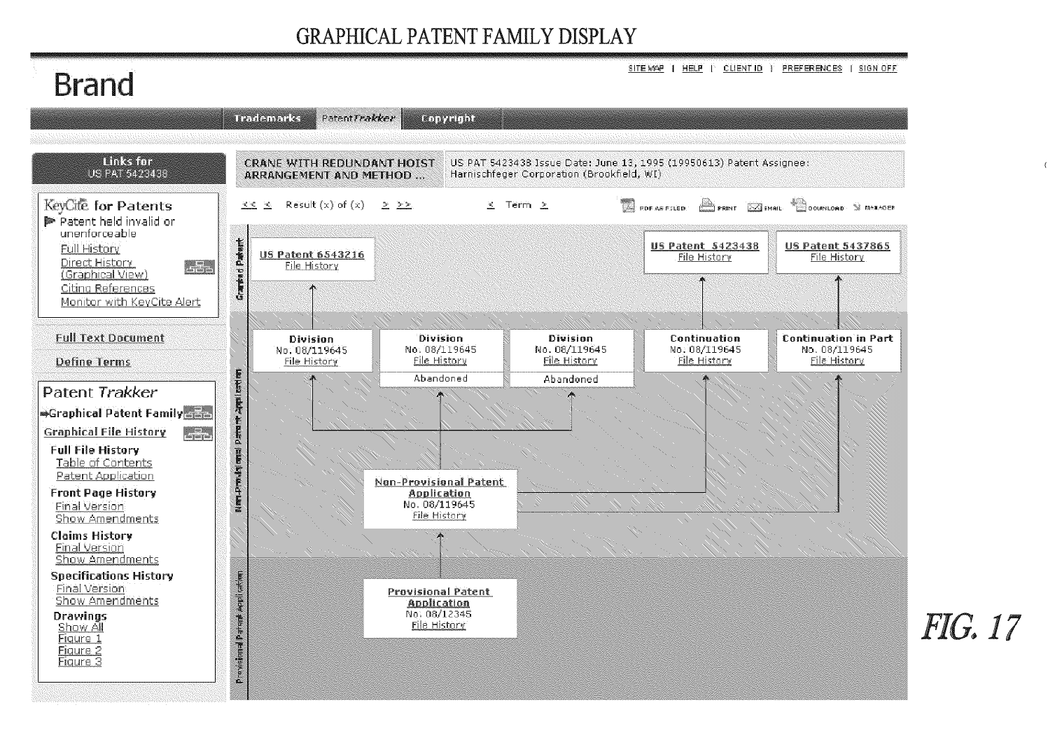

Understanding complex patent family relationships is a major pain point for attorneys researching prior art or potential patent infringement. FIG. 3 shows a link to the “Graphical Patent Family.” When the user clicks this link, FIG. 17 displays the patent/application along with all family members that claim priority to the queried patent/application (children) or that the queried patent/application claims priority to (parents). The “Graphical Patent Family” display provides an “aerial view” of patent families. As stated previously, the user has the option to print, email or download this and all other graphical displays.

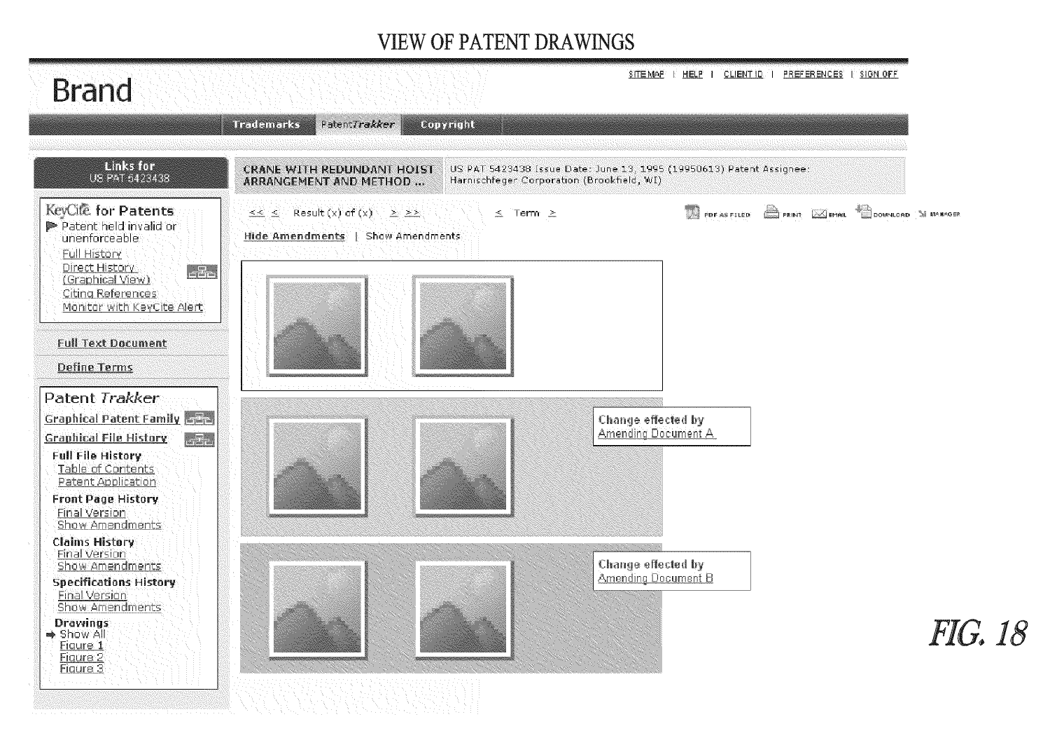

FIG. 4 shows a link to “Show All” under the “Drawings” heading. When the user clicks this link, FIG. 18 represents the drawing changes affected by amendments within the response to office actions. Another embodiment of the present invention seeks to have the figures, claims, and/or specification appear in a pop-up window when selected.

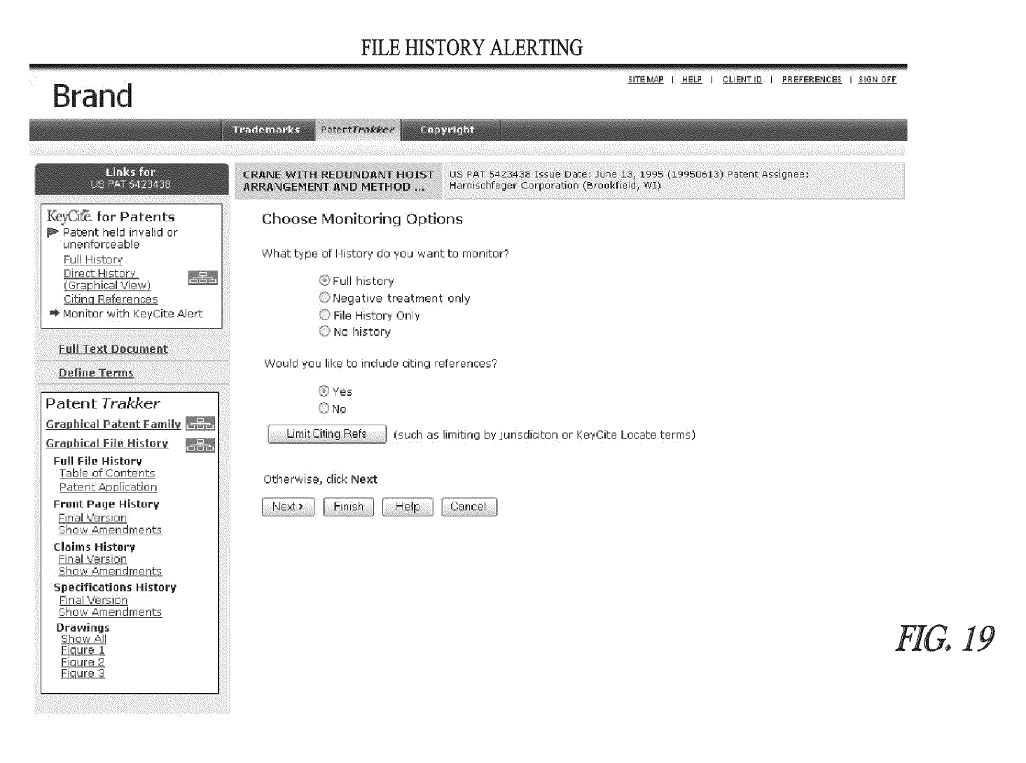

FIG. 19 allows the user to monitor patent file history with KeyCite® Alert or other monitoring/alerting system. The user can select from the option within the main display.

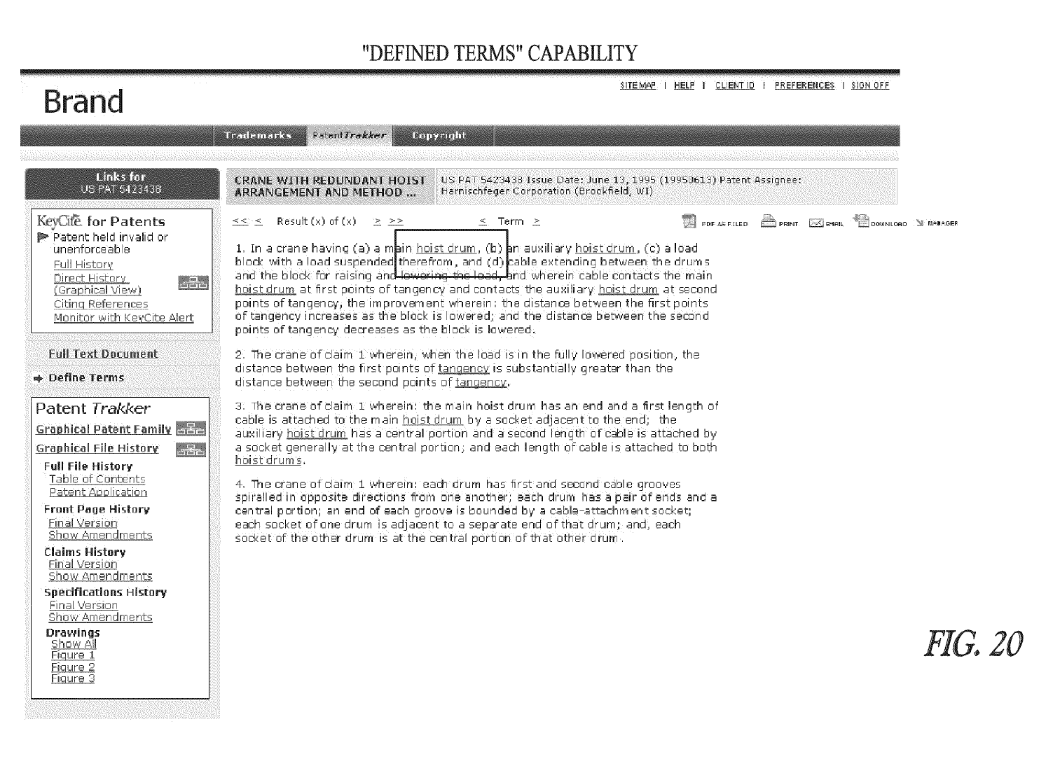

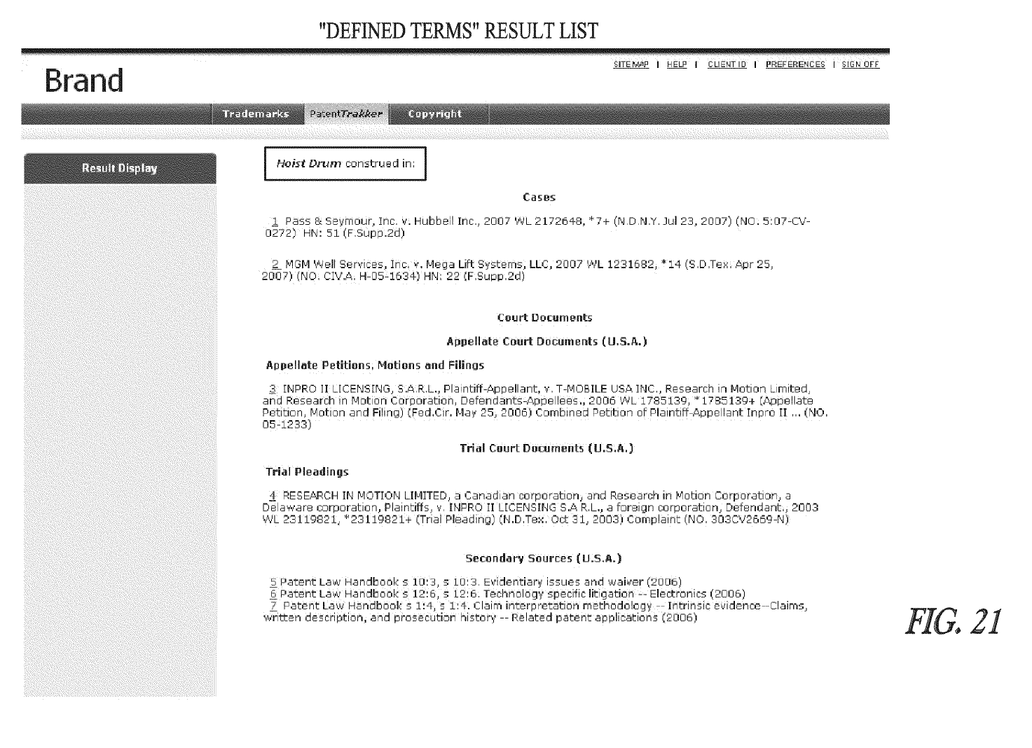

Another embodiment of the present invention gives the user term recognition/definition functionality. FIG. 20 represents hyperlinks for the terms that have courts documentation and possible secondary sources recognizing/defining the phrase or term. Understanding how claim terms have been construed by the courts is a critical part when litigating patent claim's validity. The “defined terms” feature highlights terms that have been defined. For example, the phrase “hoist drum” is recognized as having some further documentation that might aid in defining the phrase. FIG. 21 displays the defined phrase results. Included in this example's results are cases, court documents, and secondary sources that could assist the attorney in analysis.

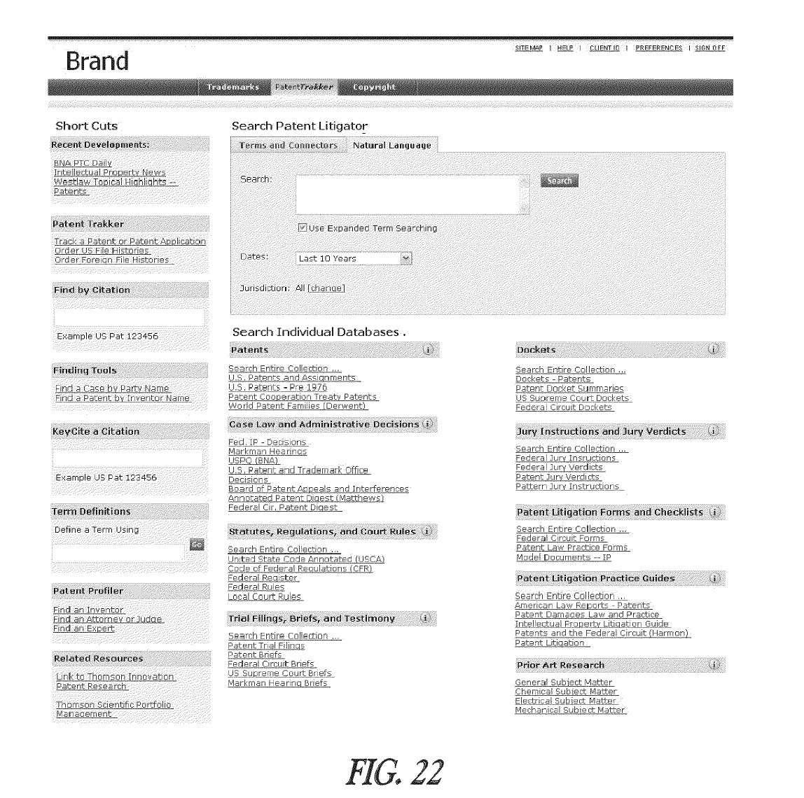

FIG. 22 shows a patent litigator tab with federated search capability.

Another embodiment of the present invention seeks to report information about the patent/application itself, the patent family, a technology area, or other patent related information. For example, an embodiment of the present invention already has shredded the file wrapper into several individual components and extracted metadata about the patent/application. The information collected and stored during those processes allows for statistical analysis. Therefore, a report could be generated on any number of topics included but not limited to examiner information (experience, workload, average turn-around time on office actions, etc.), technology area (average term of prosecution, average number of claims submitted, average number of claims allowed, average wait time for an office action, number of examiners, etc.), attorney/law firm (number of cases firm/attorney is prosecuting, average response time to an office action, average number of request for continued examinations, etc.), or any other statistics/information that could be extracted from the file wrapper of metadata.

### CONCLUSION

The embodiments described above and in the claims are intended only to illustrate and teach one or more ways of practicing or implementing the present invention, not to restrict its breadth or scope. The actual scope of the invention, which embraces all ways of practicing or implementing the teachings of the invention, is defined only by the issued claims and their equivalents.

What is claimed is:

1. A graphical user interface for an online legal research service, the interface including:
a main display region for displaying patent information;
a first user selectable control feature for causing display of a table of contents for a patent file wrapper within the main display region; and
a second user selectable control feature causing display of a redlined version of one or more patent claims.

2. The graphical user interface of claim 1, further comprising a
a third user selectable control feature for display of a graphical patent family within the main display region.

3. The graphical user interface of claim 1, wherein the table of contents includes a plurality of selectable headings and one or more of the headings having one or more corresponding selectable subheadings, which each heading and subheading identifying a corresponding section of an electronic copy of the patent file wrapper.

4. The graphical user interface of claim 2, wherein selection of the first control feature also initiates retrieval of the table of content or the patent file wrapper; wherein selection of the second control feature also initiate retrieval of the information regarding the redlined version of the one o more patent claims.

5. The graphical user interface of claim 1, wherein the first and second user selectable control features are located in a region left of the main display region.

6. The graphical user interface of claim 1, further including a third user selectable control feature for causing a displayed version of the redlined version of the one or more patent claims to change to a non-redlined version of the one or more patent claims.

7. The graphical user interface of claim 1, wherein the first and second user selectable control features are simultaneously displayed.

8. The graphical user interface of claim 1:
wherein the redlined version of one or more patent claims is associated with a first milestone in a patent application pendency; and
wherein the interface further includes a third user selectable control feature for causing display of a second redlined version of one or more patent claims that is associated with a second milestone in a patent application pendency.

9. The graphical user interface of claim 1, wherein the redlined version of the one or more patent claims causes display of known revisions to the patent claims in a color based on stored user preference information for a user.

10. The graphical user interface of claim 1, wherein each user selectable control feature is implemented as a hypertext link.

11. A method comprising:
outputting from a server to a client access device, information defining or configuring a graphical user interface, wherein the information defines:
a main display region for displaying patent information;
a first user selectable control feature for causing display of a table of contents for a patent file wrapper within the main display region; and
a second user selectable control feature causing display of a redlined version of one or more patent claims.

12. The method of claim 11, wherein the information further defines a third user selectable control feature for display of a graphical patent family within the main display region.
